(19) United States
(12) Patent Application Publication
(10) Pub. No.: US 2007/0045429 A1
(43) Pub. Date: Mar. 1, 2007

(54) Time of day zoning climate control system and method

(75) Inventors: John Gilman Chapman JR., Delaware, OH (US); Nicholas Ashworth, Dublin, OH (US); Robert Burt, Columbus, OH (US); Tony Gray, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/215,927

(22) Filed: Aug. 31, 2005

(51) Int. Cl. G05D 23/12; G05D 23/19; G05D 23/00

(52) U.S. Cl. 236/46 C; 236/51; 236/1 C; 236/94

(57) ABSTRACT

A time of day zoning control system for a heating, ventilating, and air conditioning system is provided. The system utilizes a programmable thermostat and a number of temperature sensors to control the HVAC system to regulate the temperature in a particular location within a dwelling or structure based on consumer preferences. The regulation control will utilize a temperature sensed by a particular temperature sensor at different times throughout the day to control the temperature in that zone to ensure occupant comfort. A single temperature sensor may be selected to control the HVAC system during these different periods, or multiple sensors may be utilized during the same period. When multiple sensors are used, a weighting factor may be used.

### FIELD OF THE INVENTION

The present invention relates generally to heating, ventilating, and air conditioning (HVAC) control systems, and more particularly to HVAC zoning control systems that regulate the temperature of different zones throughout a dwelling or commercial structure.

### BACKGROUND OF THE INVENTION

In most residential dwellings and many commercial structures a single thermostat is used to control the heating, ventilating, and air conditioning (HVAC) system to regulate the temperature within the dwelling. While this solution performs adequately for many consumers, it does not actually regulate the temperature in each of the different rooms or areas of the dwelling or structure particularly well. This is a result of many factors including the layout of the dwelling, how many floors are occupied, and where the thermostat is located within the dwelling or structure.

In a typical dwelling or structure, the thermostat is located in a hallway or other central area of the house. The thermostat senses the temperature at its location and controls the HVAC system to maintain the desired temperature at that location. Unfortunately, while the temperature regulation provided by the thermostat is typically very good at that location, often the occupants of the dwelling are not in the same room or location with the thermostat. Therefore, these occupants may experience wide temperature variations at their location despite the fact that the temperature is well maintained at the point of installation of the thermostat itself. This problem is particularly acute in two story dwellings where the thermostat is located on the ground floor. Since hot air rises, many consumers in such a dwelling with a typical thermostat installation complain of high temperatures on the second floor, despite the fact that at the point of installation of the thermostat the temperature is well regulated to the desired set point.

To overcome this problem, many HVAC systems now include a remote temperature sensor that may be installed in a room that is most typically occupied by the residents. In this way, the temperature in this “occupied” room can now be regulated based on the temperature sensed by the remote sensor even though the thermostat may be located in a different area of the dwelling. The thermostat in such a system is programmed to use the temperature sensed by the remote sensor rather than the temperature sensed by its internal sensor to control the HVAC system. In such a system, the temperature in the “occupied” room is now well regulated to the desired temperature set point.

However, while such systems allow for a different area of the dwelling to be well regulated by the thermostat, such systems do not address the fact that other areas of the dwelling will still experience the wider temperature variations, leading to occupant discomfort and complaint when those areas are occupied.

To address this problem other systems that utilize a remote temperature sensor include programming within the thermostat to average the temperature readings from the remote and the internal sensors for control of the HVAC system. Such averaging type HVAC control systems are particularly good in two story dwellings. In such a system a remote sensor is typically placed on the second floor while the internal sensor of the thermostat is installed on the first floor. By averaging the temperature sensed by the remote and the internal sensors, the control of the HVAC system is adjusted to try to maintain a comfortable temperature on both the second and first floor.

However, with any averaging type system, neither zone will necessarily be regulated to the desired set point temperature. That is, while wide temperature variations in the location of the remote sensor and of the thermostat are precluded, neither zone is particularly well controlled to the desired set point temperature set by the consumer. Such a system also fails to recognize that different areas of the dwelling are occupied at different times during the day. That is, in the averaging type control system the control of the temperature on the first floor during the day is affected by the temperature on the second floor even though the second floor is typically not occupied during the daylight hours, and the temperature of the second floor at night is affected by the temperature on the first floor even though the first floor is typically not occupied during the night time hours.

To provide better temperature zone control, some consumers have installed an HVAC zone control system in the dwelling. Such a zoning control system requires that dampers, damper controllers, and thermostats be installed in every area of the dwelling or structure to insure adequate temperature control in each of these various areas. However, as may well be imagined, such a system is vastly more expensive than a typical thermostat controlled HVAC system. As such, most consumers find this system too expensive to be considered, despite the fact that it provides regulated temperature control in each area of the residence or structure.

There exists therefore, a need in the art for a HVAC control system that is capable of regulating the temperature in various areas of a dwelling based on the likely occupancy of those areas during different times of the day.

The invention provides such a time of day zoning climate control system and method. These and other advantages of the invention, as well as additional inventive features, will be apparent from the description of the invention provided herein.

### BRIEF SUMMARY OF THE INVENTION

The present invention provides a new and improved HVAC control system that overcomes the above-described and other problems existing in the art. More particularly, the present invention provides a new and improved HVAC control system that provides time of day zoning control to better regulate the temperature of the zone in which occupants are likely to be at different times of the day to improve overall occupant comfort throughout the dwelling or structure without the necessity of installing costly zone control equipment. Even more particularly, the present invention provides a new and improved time of day zoning control system that allows a user to select which areas of a dwelling or structure will be monitored to control the HVAC system during different times of the day based on the likely occupancy of those areas.

In one embodiment of the present invention, a programmable thermostat is provided that targets certain temperatures in the dwelling or structure at certain times. In this way, the programmable thermostat of the present invention controls the temperature in certain areas of the dwelling or structure at certain times during the day. By allowing an occupant to program the thermostat for which sensor is to be used at specific times throughout the day, the thermostat is better able to provide comfort to the occupants as they move from one area to another throughout the day by controlling the temperature in the space most likely occupied at that time. Preferably, the system of the present invention provides an internal temperature sensor within the programmable thermostat as well as at least one and preferably a plurality of remote sensors that may be placed in different zones or rooms in the dwelling or structure.

In a preferred embodiment of the present invention, the programmable thermostat includes a schedule menu that allows the user to select which sensor is to be used to control the HVAC system at a given time of the day. As an example of such programming in an exemplary embodiment that utilizes a single internal temperature sensor within the thermostat and a single remote temperature sensor placed in the home's sleeping area, the homeowner may set the thermostat to control the temperature based on the remote temperature sensor from 10:30 p.m. until 8:00 a.m., and can program the thermostat to control the temperature based on the internal temperature sensor from 8:00 a.m. until 10:30 p.m. In such an exemplary embodiment, this programming reflects the user's desire that the temperature be controlled at the remote sensor placed in the home's sleeping area during the hours that the occupants of the dwelling are typically in the sleeping area, and be controled at the internal temperature sensor of the thermostat that is installed in the home's living area during those hours when the occupants are most likely in that area.

In one embodiment of the present invention, the times of the events that may be selected by the user in the programming of the thermostat are tied to the existing HVAC schedule. In an alternate embodiment of the present invention, the times for these events that may be programmed by the user may be independent of the existing HVAC schedule. The number of remote sensors and the times at which the thermostat uses selected temperature sensors may vary as desired based on system resources, consumers desires, and costs.

In an alternate embodiment of the present invention, the system allows a consumer to add a weighting factor to each of the sensors. This weighting factor is utilized by the thermostat to control the HVAC system so that the temperature regulation in one area of the home is regulated without completely ignoring another area of the dwelling. This weighting may also be set to equally weight both/all sensors, which is essentially an averaging function.

In the exemplary embodiment discussed above, an example of such weighting of the sensor inputs may have the consumer placing 80% of the HVAC control based on the remote sensor located in the sleeping area and 20% based on the internal temperature sensor in the thermostat located in the living area from 6:00 a.m. until 8:00 a.m. The user may then place, e.g., 100% based on the internal temperature sensor from 8:00 a.m. until 5:00 p.m. The user may then program 10% based on the remote sensor located in the sleeping area and 90% based on the internal temperature sensor in the thermostat located in the living area from 5:00 p.m. until 10:30 p.m. Finally, the user may set 100% of the HVAC control based on the remote sensor located in the sleeping area from 10:30 p.m. until 6:00 a.m.

Such programming would indicate that the user wants the remote sensor to carry 80% of the demand for regulation and the internal sensor only to carry 20% of the demand from 6:00 a.m. to 8:00 a.m. recognizing that the occupants will be transitioning from the sleeping area to the living area during that period. Such would recognize a consumer's preference that when they leave the sleeping area for the living area to, for example, have breakfast, the consumer does not want the living area to be uncomfortable. However, once the consumer has left the sleeping area for the day, the full HVAC control may be based on the internal sensor since the occupants will be unlikely to return to the sleeping area during the daylight hours for any extended period of time. However, in the evening the consumer may want part of the regulation based on the remote sensor in the sleeping area to prepare this area for eventual occupancy during the evening and night time hours. Once the occupant has transitioned to the sleeping area in the night time hours, the control of the HVAC system will be based solely on the remote temperature sensor located in that sleeping area.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention;

FIG. 2 is a simplified dwelling diagram illustrating principles of the present invention; and

FIGS. 3-16 illustrate user display screens generated by and usable with the embodiment of the thermostat of the present invention illustrated in FIG. 1 for programming the time of day zoning control of the HVAC system.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

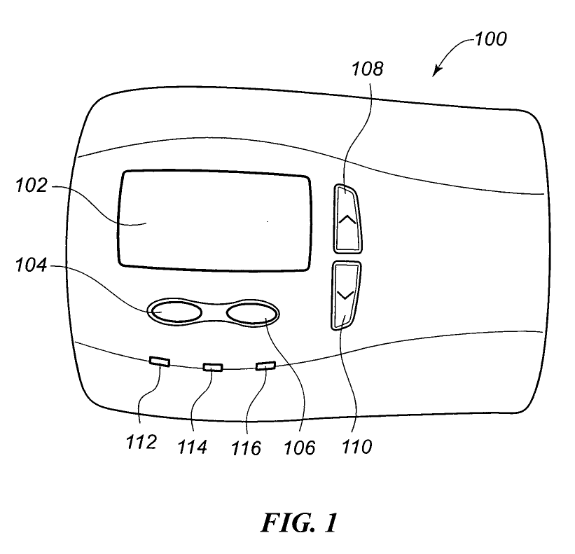

An embodiment of a thermostat constructed in accordance with the teachings of the present invention to incorporate the time of day zoning control of the HVAC system of the invention is illustrated in FIG. 1. As with many thermostats, an internal temperature sensor is included within the thermostat 100. As may be seen from this FIG. 1, this embodiment of the thermostat 100 includes a user display 102 on which is displayed programmatic, system, and ambient information regarding the operation of the HVAC system. This user display 102 may take various forms as are well-known in the art, and in a preferred embodiment is a dot matrix LCD display. With such a display 102, the consumer may activate various programmatic and control functions via a pair of soft keys 104, 106. The functionality executed by these soft keys 104, 106 varies dependent upon the programmatic state in which the thermostat 100 is at the time one of the soft keys 104, 106 is depressed. The particular functionality that will be instituted upon selection of one of the soft keys 104, 106 is displayed in an area of the user display 102 proximate the key 104, 106 which will institute that function. That is, the function that will be instituted upon selection of soft key 104 will be located generally in the lower left hand portion of user display 102 while the functionality that will be instituted by selection of soft key 106 will be located generally in the lower right hand portion of user display 102. These functional indicators may change depending on the program state and mode in which the thermostat is currently operating.

In addition to the soft keys 104, 106, this embodiment of the thermostat 100 of the present invention also includes adjustment keys 108, 110. These adjustment keys 108, 110 may serve to adjust a currently selected parameter up or down, such as in the case of setting the control temperature at which the thermostat will maintain the ambient environment. Additionally, these keys 108, 110 may scroll through the available data for a selected parameter, such as scrolling through alphanumeric data that may be selected for a given parameter. These keys 108, 110 may also function as soft keys depending on the programmatic state in which the thermostat is operating. When this functionality is provided, the function that will be instituted by selection of key 108 will be provided generally in the upper right hand corner of display 102, while the functionality that will be instituted by selection of key 110 will be displayed generally in the lower right hand corner of user display 102. In addition to the above, other use input means, such as an alphanumeric keypad, user rotatable knob, a touch screen, etc. may be utilized instead of the buttons 104-110 illustrated in the embodiment of FIG. 1.

In this embodiment, the thermostat 100 also includes operating mode visual indicators 112, 114, 116. These indicators 112-116 provide a visual indication of the current operating mode of the thermostat. In the embodiment illustrated in FIG. 1, indicator 112 will illuminate while the thermostat 100 is operating in the cooling mode. Indicator 116 will illuminate while the thermostat 100 is operating in the heating mode. Finally, indicator 114 will illuminate to indicate that the fan is operating. Depending on the particular application, this indicator 114 may illuminate whenever the fan is running, or may illuminate only when the fan is selected to run continuously.

In embodiments of the present invention that do not utilize automated switching control between the heating and cooling modes of operation, these indicators 112-116 may operate as user selectable switches to allow the consumer to select the operating mode of the thermostat 100. For example, during the summer months the consumer may select the cooling mode by depressing indicator 112. In this mode, the furnace will not be turned on even if the interior ambient temperature drops below the set point. To switch from the cooling to the heating mode of operation, the consumer, in this alternate embodiment, would need to select indicator 116 to allow the thermostat 100 to operate the furnace. Consumer selection in this embodiment of indicator 114 would operate the fan continuously, as opposed to its normal automatic operation based upon a call for cooling or heat by the thermostat 100. In a still further embodiment of the present invention, the indicators 112-116 may also be utilized to provide a visual indication of system trouble, or that there is a system reminder message being displayed on user screen 102.

Having discussed the physical structure of one embodiment of a thermostat 100 constructed in accordance with the teachings of the present invention, the discussion will now focus on the time of day zoning control of the HVAC system which forms an aspect of the present invention. Indeed, while the following discussion will utilize the structure of the thermostat 100 illustrated in FIG. 1, those skilled in the art will recognize that various other structures can be utilized without departing from the spirit and scope of the present invention. That is, regardless of the user input mechanisms utilized by the particular embodiment of the thermostat 100 of the present invention, the programmatic steps and display information provided in the following discussion may be used.

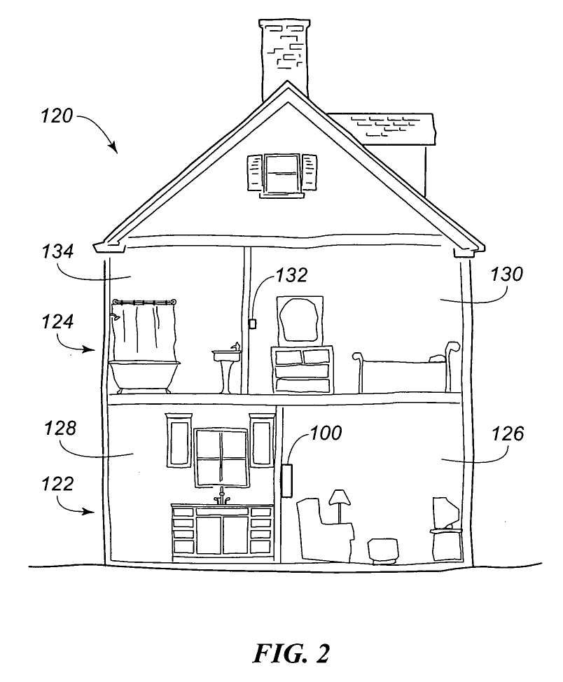

The time of day zoning provided by the thermostat 100 of the present invention may be better understood with reference to the simplified dwelling illustration of FIG. 2. This FIG. 2 is meant to illustrate, in simplified form, a two-story dwelling in which the system of the present invention may find particular applicability. This exemplary dwelling 120 includes both a first floor 122 and a second floor 124 on which occupants of the dwelling 120 may spend extended periods of time. Additional or fewer floors may also be provided in dwellings in which the system of the present invention may also find applicability.

In this simplified FIG. 2, a thermostat 100 is installed on the first floor 122 in an area 126 that is most likely to be occupied during certain periods of the day. While the first floor 122 also includes other areas 128 that may be occupied during the day, the exemplary system installed in the dwelling 120 of FIG. 2 does not include a remote temperature sensor in this other area 128. However, in other embodiments of the present invention, remote temperature sensors may be installed in these other areas as desired by the consumer for regulation of the temperature therein based upon the likely occupancy of those areas during particular times of the day. Indeed, in embodiments where the thermostat 100 is installed in areas that are not typically occupied, e.g. a hallway, a remote temperature sensor may be installed in the areas 126 that are most likely occupied.

The second floor 124 of the exemplary dwelling 120 shown in FIG. 2 also includes an area 130 on the second floor 124 in which a remote temperature sensor 132 is installed. This area 130 was chosen for installation of the remote temperature sensor 132 based on the consumer's likely occupancy of this area 130 during particular times of the day. As with the first floor 122, the second floor 124 includes other areas 134 that may also be occupied during periods of the day, but in which the consumer has chosen not to install a remote temperature sensor. This decision to not install a temperature sensor in a particular area of the dwelling 120 is not based upon a limitation of the system of the present invention, but instead based on cost or other concerns of the consumer, or the consumer's lack of desire to provide specific temperature regulation of such areas during particular times of the day.

In the exemplary dwelling 120 shown in FIG. 2, the temperature regulated zone 126 on the first floor 122 may be, e.g., a family room or living room where the occupants of the dwelling spend a good deal of time throughout the day. The un-temperature-regulated area 128 of the first floor 122 may be a kitchen or dining room where the occupant is not so concerned with specific temperature regulation during the brief periods throughout the day when these areas are occupied. However, as indicated above, the system of the present invention can accommodate the installation of a remote temperature sensor in such areas to provide regulation thereof at the desire of the consumer.

The temperature regulated area 130 of the second floor 124 may be, for example, a bedroom or sleeping area where the occupants spend a significant period of time, typically during the nighttime hours. The un-temperature-regulated areas 134 may be, for example, a bathroom or other area that the consumer is not so concerned with specific temperature regulation therein. However, as discussed above, the system of the present invention would allow for the installation of a remote temperature sensor in these currently unregulated areas 134. The communication of temperature information from the remote temperature sensor 132 to the thermostat 100 may be via wired connection or wireless communication as is known in the art.

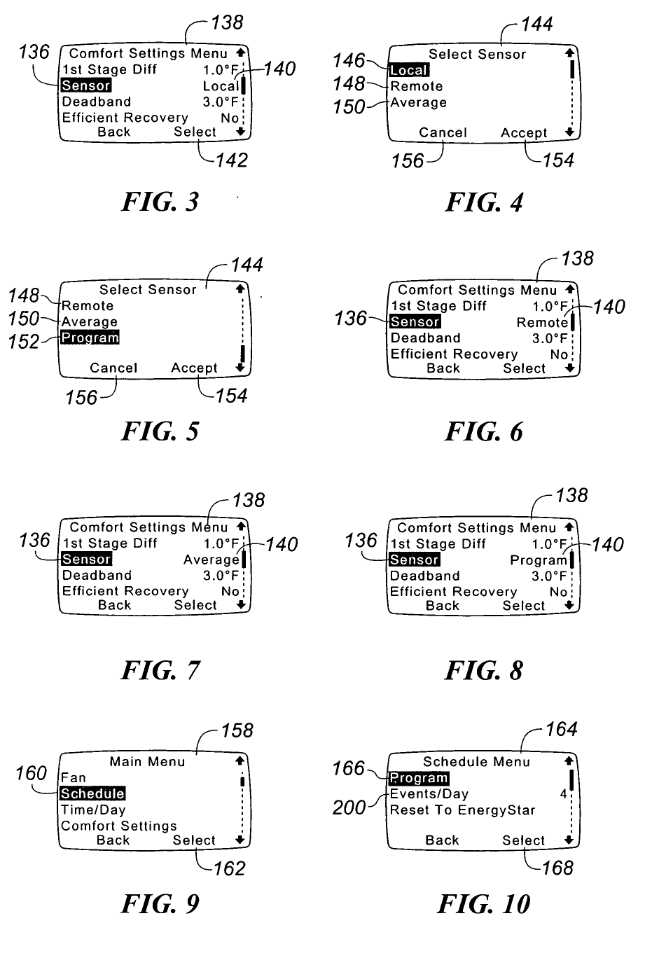

In an embodiment of the present invention that utilizes the soft key menu driven thermostat 100 illustrated in FIG. 1, the selection and programming of the thermostat 100 to utilize the internal and remote temperature sensors may be accessed through menus displayed on screen 102. In one embodiment of the present invention, a comfort settings menu, such as that illustrated in FIG. 3, may be accessed by a consumer to configure the system of the present invention. As illustrated in this exemplary menu of FIG. 3, a sensor setting 136 is displayed on the comfort settings menu 138. This sensor setting 136 includes an indication 140 of the current sensor setting for control of the HVAC system. To change this sensor setting 136, a user would depress soft key 106 (see FIG. 1) since this soft key 106 is in close proximity to the select functional indication 142.

Once this select functionality 142 has been indicated by the depression of soft key 106 (see FIG. 1), an embodiment to the present invention will display the select sensor menu 144 illustrated in FIG. 4. This select sensor menu 144 displays the available choices for control of the HVAC system based on temperature readings taken by the local or internal temperature sensor 146, by a remote temperature sensor 148, an average of the temperature readings from the temperature sensors 150 or, as illustrated in FIG. 5, a program setting 152. The additional options illustrated in the select sensor menu 144 of FIG. 5 are accessed by depression of the selection key 110 to scroll down to view the additional options that do not appear on the display. Once the user has selected the desired sensor via selection of selector keys 108, 110, the user would depress soft key 106 that is in proximity to the accept functionality 154. If, however, the user decided not to accept any changes to the selection sensor menu 144, the user could simply depress soft key 104 in proximity to the cancel functionality 156.

If the user were to select the remote temperature sensor 148 for regulation of the HVAC system, the display 102 would return to the comfort settings menu 138 illustrated in FIG. 6. As may be seem from this exemplary menu 138 in FIG. 6, the sensor selection 136 now indicates at 140 that the remote sensor will be utilized to control the HVAC system.

If, however, the user had selected the average selection 150 from the select sensor menu 144 of FIG. 4, the comfort settings menu 138 would indicate at 140 that the sensor selection 136 for control of the HVAC system is now set to average the temperature readings from the local and remote temperature sensors. This functionality will operate to control the HVAC system based on equally weighted average of the temperature sensed by both the internal or local temperature sensor and the remote temperature sensor(s) installed in the system.

Returning to the selection sensor menu 144 illustrated in FIG. 5, the system of the present invention also provides a program setting 152 that may be selected by depression of soft key 106 located in proximity to the accept functionality 154. Once the user selects the program functionality 152, the comfort settings menu illustrated in FIG. 8 will reflect this selection in area 140. Once this program functionality has been selected by the user, the user will then be able to program the thermostat 100 to use any one of the temperature sensors installed in the system, an average of such sensors, a weighted average of such sensors, or any combination thereof as desired.

In one embodiment of the present invention, the user of thermostat 100 may change the programming through the main menu 158 illustrated in FIG. 9. By using the select keys 108, 110 (see FIG. 1), the user can select the schedule option 160 by highlighting it and selecting the soft key 106 in proximity to the select functionality 162.

Once this selection has been made, an embodiment of the present invention displays a schedule menu 164 such as that illustrated in FIG. 10. From this schedule menu 164 the user is able to select the program functionality 166 by highlighting it using select keys 108, 110 and then depressing soft key 106 in proximity to the select functionality 168 displayed thereon.

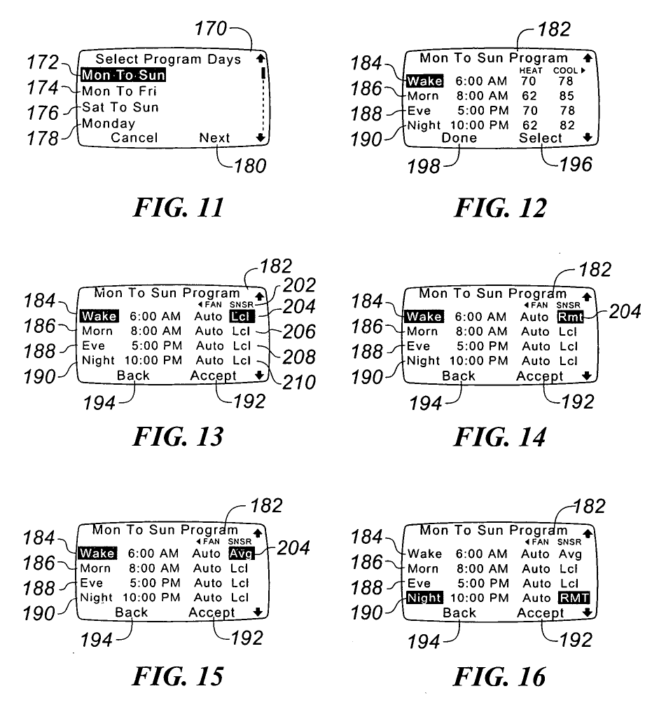

Once the program function 166 has been selected, and embodiment of the present invention displays a select program days menu 170 such as that illustrated in FIG. 11. This select program days menu 170 provides the user with various options to select different groupings of days, or individual days to establish a program for control of the HVAC system on those selected groupings of days or individual days as desired by the consumer. Preferably, an option 172 is provided to allow a consumer to set a single programming schedule for the entire week, an option 174 to allow a consumer to set a program schedule for the weekdays, an option 176, to allow a consumer to set a schedule for the weekend days, and a number of individual day options 178 that will allow a consumer to set individual programs for each particular day of the week. Once the desired grouping of days or individual day is selected via the select keys 108, 110, the consumer then depresses the soft key 106 in proximity to the next functionality 180 to proceed with the programming of the thermostat 100.

Assuming for this dicussion that the consumer has selected the Monday to Sunday programming option 172, the Monday to Sunday program screen 182 illustrated in FIG. 12 is displayed. This full week programming menu 186 displays a number of events during each day to control the HVAC system, such as a wake period 184, a morning period 186, an evening period 188, and a night period 190. However, the number of events per day may also be changed in the system of the present invention by selecting the events/day option 200 from the schedule menu 164 illustrated in FIG. 10.

However, assuming that four events per day have been selected by the consumer as illustrated in FIG. 12, the consumer can change the programming of the options for each of these events by selecting the desired event through the selection keys 108, 110 (FIG. 1) and depressing soft key 106 in proximity to the select function 196. As the user cycles through each of the adjustable parameters for each of the events, e.g., time, heat temperature, cool temperature, fan operation, and sensor, the next adjustable parameter is selected.

As illustrated in FIG. 13, when the consumer has reached the sensor parameter 202 on the program menu 182, an indication is given at locations 204, 206, 208, 210 for each of the corresponding events 184-190, respectively, regarding what sensor or combination of sensors will be used to control the HVAC system. As indicated in FIG. 13, initially this embodiment of the present invention has the local or internal temperature sensor within thermostat 100 selected, as indicated by the Lcl indication, to control the HVAC system. This sensor may be changed by using the select keys 108, 110 (FIG. 1). FIG. 14 illustrates the program screen 182 as the user changes the option for the control sensor from local to the remote sensor, and FIG. 15 illustrates this screen 182 as the consumer changes to an average of the installed temperature sensors as indicated in location 204.

Once the consumer has reached the desired sensor for that event, the consumer depresses soft key 106 in proximity to the accept functionality 192. If, however, the consumer wanted to change a previous option, the consumer would depress soft key 104 in proximity to the back functionality 194. Once each of the programmable settings for each of the events have been programmed, the screen of FIG. 12 is then displayed to allow the user to select soft key 104 in proximity to the done functionality 198 to end the programming set-up. The thermostat will then control the HVAC system based on the programmatic inputs from the consumer.

As illustrated in FIG. 16, the consumer has indicated a desire in this example to have the HVAC system controlled based on an average of the local and remote sensors from 6:00 a.m. until 8:00 a.m., based on the local sensor from 8:00 a.m. until 10:00 p.m., and then based on the remote sensor from 10:00 p.m. until 6:00 a.m. the next morning. At any point, the consumer may modify the programming of the thermostat 100. Additionally, while not explicitly illustrated in screen shots, the system of the present invention also allows the various temperature sensors located throughout the dwelling or structure to be given a weighting factor as opposed to a straight averaging of the inputs therefrom for control of the HVAC system.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A heating, ventilating and air conditioning (HVAC) system control system, comprising:
a programmable thermostat;
at least two temperature sensors in communication with the thermostat, at least one of the at least two temperature sensors adapted to be located remotely from the thermostat; and
wherein the thermostat is programmable to control the HVAC system based on a first temperature sensed by one of the at least two temperature sensors during a first period of a day and based on a second temperature sensed by another of the at least two temperature sensors during a second period of the day.

2. The control system of claim 1, wherein one of the at least two temperature sensors is located within the thermostat.

3. The control system of claim 1, wherein at least one of the at least two temperature sensors are in wireless communication with the thermostat.

4. The control system of claim 1, wherein the thermostat is programmable to control the HVAC system based on an average of the first temperature sensed by one of the at least two temperature sensors and the second temperature sensed by another of the at least two temperature sensors at a third period of the day.

5. The control system of claim 1, wherein the thermostat is programmed to control the HVAC system based on a weighted average of the first temperature sensed by one of the at least two temperature sensors and the second temperature sensed by another of the at least two temperature sensors at a third period of the day.

6. The control system of claim 1, wherein the thermostat comprises:
a user display screen;
a user function selection means for inputting a user selection associated with a function indicated on the user display screen;
a user scrolling means for allowing a user to scroll among available items and parameters; and
wherein the thermostat displays a select sensor screen on the user display, the select sensor screen providing a program selection allowing a user to program which of the at least two sensors are to be used by the thermostat to control the HVAC system during different periods of the day.

7. The control system of claim 6, wherein the thermostat displays a select program days screen on the user display, the select program days screen providing user selectable options for groupings of days and individual days for which programming will be effective.

8. The control system of claim 7, wherein the thermostat displays a programming screen for a selected grouping of days or a selected individual day having a plurality of events displayed thereon, and wherein the programming screen allows a user to change which of the at least two sensors are used by the thermostat to control the HVAC system during each of the plurality of events.

9. The control system of claim 8, wherein the thermostat displays a schedule menu from which a user can change how many events are available for control of the HVAC system.

10. A method of enhancing occupant comfort in a multi-zonal dwelling having a single thermostat to control temperature regulating equipment therefore, comprising the steps of:
sensing a first temperature in a first area of the dwelling during a first period;
regulating the first temperature of the first area during the first period based on the step of sensing the first temperature in the first area;
sensing a second temperature in a second area of the dwelling during a second period; and
regulating the second temperature of the second area during the second period based on the step of sensing the second temperature in the second area.

11. The method of claim 10, further comprising the steps of:
sensing the first temperature in the first area and the second temperature in the second area during a third period; and
regulating the temperature in the first area and in the second area based on an average of the first temperature and the second temperature.

12. The method of claim 11, further comprising the step of applying a first weighting factor to the first temperature and a second weighting factor to the second temperature, and wherein the step of regulating the temperature in the first area and in the second area based on an average of the first temperature and the second temperature comprises the step of regulating the temperature in the first area and in the second area based on a weighted average of the first temperature and the second temperature.

13. The method of claim 10, further comprising the steps of:
selecting one of the first temperature and the second temperature to be sensed during the first period based on probable occupancy of the first area and the second area during the first period; and
selecting one of the first temperature and the second temperature to be sensed during the second period based on probable occupancy of the first area and the second area during the second period.

14. The method of claim 10, further comprising the steps of:
sensing one of the first temperature or the second temperature during a third period; and
regulating the sensed one of the first temperature or the second temperature during the third period.

15. A time of day climate control method of controlling temperature regulating equipment in a multi-room structure to enhance occupant satisfaction, comprising the steps of:
receiving a first user programming input to select a first area of the structure from which to sense temperature during a first period;
receiving a second user programming input to select a second area of the structure from which to sense temperature during a second period; and
controlling the temperature regulating equipment during the first and the second periods in accordance with the first and the second user programming inputs.

16. The method of claim 15, further comprising the step of displaying a select sensor screen having user selectable options for selection of temperature sensors in the first and the second area of the structure allowing a user to program which of the sensors are to be used to control the temperature regulating equipment during different periods of the day.

17. The method of claim 16, further comprising the step of displaying a select program days screen having user selectable options for groupings of days and individual days for which programming will be effective.

18. The method of claim 17, further comprising the step of displaying a programming screen for a selected grouping of days or a selected individual day having a plurality of user selectable events displayed thereon allowing a user to program which of the sensors are to be used to control the temperature regulating equipment during each of the plurality of events.

19. The method of claim 18, further comprising the step of displaying a schedule menu from which a user can change how many events are available for control of the temperature regulating equipment during a day.

20. The method of claim 15, further comprising the steps of:
receiving a third user programming input to select a third area of the structure from which to sense temperature during a third period;
receiving a fourth user programming input to select a fourth area of the structure from which to sense temperature during a fourth period; and
controlling the temperature regulating equipment during the third and the fourth periods in accordance with the third and the fourth user programming inputs.
